(19) United States
(12) Patent Application Publication
(10) Pub. No.: US 2023/0166403 A1
(43) Pub. Date: Jun. 1, 2023

(54) AN INDUSTRIAL ROBOT SYSTEM

(71) Applicant: ABB Schweiz AG, Baden (CH)

(72) Inventors: Yang Gao, Västerås (SE); Roger Kulläng, Västerås (SE); Mikael Norrlöf, Norrköping (SE); Mattias Björkman, Västerås (SE); Per Willför, Västerås (SE)

(21) Appl. No.: 17/997,005

(22) PCT Filed: Apr. 24, 2020
(86) PCT No.: PCT/EP2020/061538

§ 371 Date: Oct. 24, 2022

(51) Int. Cl. B25J 9/16; G05B 19/4155

(52) U.S. Cl. CPC B25J 9/1682; B25J 9/1602; G05B 19/4155; G05B 2219/50391

(57) ABSTRACT

An industrial robot system including a first robot. The first robot includes a first manipulator with a base and a tool movable in relation to the base about a plurality of axes, and a first primary controller having a primary robot functionality, the primary robot functionality including control of manipulator motion. The industrial robot system further includes a plurality of secondary controllers, each having a secondary robot functionality, wherein the primary robot functionality is different from all of the secondary robot functionalities, and wherein an overall robot functionality is defined by the primary robot functionality and one or more secondary robot functionalities.

### TECHNICAL FIELD

The present invention relates generally to an industrial robot system. The invention more particularly relates to a method and robot system for distributing robot functionality of at least one robot among more than one controller entities.

### BACKGROUND

Robots are frequently used within the industry in a variety of operations such as e.g., for manufacturing objects. An industrial robot typically comprises a manipulator movable about a plurality of axes, a tool attached to the manipulator and configured to perform an action, such as e.g. gripping, a robot controller configured to control the robot, and a control unit having a user interface adapted to communicate with the robot controller and to enable programming of the robot. The typical robot controller may include, or be prepared for, many functions, such as HMI, I/O system, fieldbus support, etc.

In many robot cells, more than one robot collaborates to perform an operation or overall process. Thus, the individual robot actions or performances are different from the overall operation.

However, depending on the purpose of the robot, process software and hardware resources of the robot controller varies. Moreover, as the purpose of the robot, and the intended overall process may change, the actions or performances of the individual robots, i.e. their functionalities, may change accordingly. This typically requires adaptation of the robot and robot controllers, and sometimes the robot needs to be exchanged to another robot with different functionality.

Thus, there exists a need for a more versatile and flexible use of the functionality of the robot.

### SUMMARY

An object of the present invention is to overcome the above problems, and to provide a robot system which, at least to some extent, is improved compared to prior art solutions. This, and other objects, which will become apparent in the following are accomplished by means of an industrial robot system comprising at least a first robot having a first manipulator and a first primary controller, and a plurality of secondary controllers, and a method for distributing robot functionality of the first robot.

According to a first aspect of the present invention, an industrial robot system comprising a first robot is provided. The robot comprises a first manipulator with a base and a tool movable in relation to the base about a plurality of axes, and a first primary controller having a first primary robot functionality, the first primary robot functionality including control of manipulator motion, wherein the industrial robot system further comprises a plurality of secondary controllers, each having a secondary robot functionality, wherein the first primary robot functionality is different from all of said secondary robot functionalities, and wherein an overall robot functionality is defined by the first primary robot functionality and one or more secondary robot functionalities.

Hereby, the first primary controller becomes compact in size and low in cost. As was mentioned previously, there exists a need for a more versatile and flexible use of the functionality/functions of the robot, and the present invention provides this by providing a robot which is able to perform its primary functions by the first primary robot functionality of the first primary controller, and having all other possible functionalities of the robot, the robot cell, and/or process (e.g. a process comprising multiple robot cells) allocated to the secondary controllers. Thus, the industrial robot system is very adaptable as different secondary functionalities can be added to the overall robot functionality based on desired needs. In other words, the industrial robot system according to the invention provides an overall robot functionality which is scalable as the first primary robot functionality can be scaled-up by one or more of the secondary robot functionalities.

Moreover, by including only first primary robot functionality in the first primary controller, the first primary controller is scaled down compared to a conventional robot controller. According to at least one example embodiment, the first primary controller comprises solely the manipulator motion functionality. That is, according to such embodiment, the first primary robot functionality is manipulator motion functionality.

According to at least one example embodiment, the secondary robot functionality is any robot functionality provided by the secondary controllers. Thus, it should be understood that according to at least one example embodiment, the secondary robot functionality may include the same functionality as the first primary robot functionality, e.g. manipulator motion control, but that the first primary robot functionality typically does not include anything other than the first primary robot functionality. By keeping all functionality other than the first primary robot functionality outside of the first primary controller, the first primary controller can be made simple and compact.

According to at least one example embodiment, the first primary robot functionality is different to the overall secondary robot functionality, i.e. the sum of secondary robot functionalities of the secondary controllers. According to at least one example embodiment, the first primary robot functionality is different to each one of the secondary robot functionalities. The secondary robot functionality of a specific secondary controller is e.g., the total secondary robot functionality in that secondary controller. According to at least one example embodiment, none of the second robot functionalities is included in the first primary robot functionality. According to at least one example embodiment, the secondary robot functionalities are different from each other.

According to at least one example embodiment, the first primary controller is integrated into the first manipulator, for example into an arm of the first manipulator.

For instance, the first primary controller can be affected by a number of environment limitations, such as e.g. space requirements in the robot, processing capacity limitations, storage/memory capacity, available memory, etc. As an example, the space requirements of the robot may impose restrictions on the size of the first primary controller. Likewise, if there are processing resource constraints in the first primary controller, the computation that has been designed to be executed locally on the robot will be limited to the specific robot application performance. By providing certain robot functionality in at least one secondary controller (external of the first manipulator, or even external of the robot and/or the robot cell) such as e.g., in the cloud or in another local robot controller, it is possible to provide a robot with a wide variety of functionality which still is integratable into the first manipulator.

Thus, by distributing the robot functionality in the industrial robot system such that the first primary controller includes first primary robot functionality, and any secondary robot functionality is distributed to secondary controllers, the first primary controller can be made compact to enable integration into the first manipulator. Hereby, the controller is integrated in the same element which it serves to control, namely the first manipulator, which is advantageous e.g., with regards to signal processing and response times.

According to at least one example embodiment, the plurality of secondary controllers is arranged externally of the first manipulator.

Thus, the secondary controllers are, according to this example embodiment, not integrated into the first manipulator. Thus, the size restrictions for the secondary controllers may be less strict than for the first primary controller. At least one of the secondary controllers may be located in the robot cell.

According to at least one example embodiment, the industrial robot system further comprises a network arrangement for distributing robot functionality of the first robot among the first primary controller and one or more of the secondary controllers.

Hereby, the overall robot functionality can be distributed in an efficient manner, and any secondary robot functionality easily added to the robot to extend or scale-up its functionality beyond the first primary robot functionality. The network communication could be realized with the use of real-time network such as TSN or wireless like 5G.

According to at least one example embodiment, the network arrangement comprises a functionality determining unit configured to obtain data about available functionality for the first robot and to determine, based on said available functionality, whether a desired robot functionality can be carried out or not.

Hereby, the industrial robot system can decide whether the robot, or robot system, can carry out the desired robot functionality or robot performance (e.g., by a requested function) or not. The functionality determining unit may alternatively or additionally be configured to determine if the robot functionality corresponding to the desired robot functionality is available in the first primary robot functionality and/or secondary robot functionalities.

According to at least one example embodiment, the first primary controller, and each secondary controller, comprises process software and hardware resources to carry out the associated functions of the primary and secondary robot functionalities.

For example, the first primary controller comprises process software and hardware resources to carry out the first primary robot functionality, and each secondary controller comprises process software and hardware resources to carry out its associated secondary robot functionality. Hereby, the process software and hardware recourses can be optimized with regards to the function(s) which it is intended for. The process software and hardware resources may e.g., be embodied by a computer and logic unit in the first primary controller and each one of the secondary controllers, respectively.

According to at least one example embodiment, the first primary robot functionality of the first primary controller includes the control of at least integrated process equipment of the robot.

According to at least one example embodiment, the first primary robot functionality comprises, such as e.g. solely comprises, motion control of the manipulator and any tool attached thereto.

According to at least one example embodiment, the first primary controller comprises robot safety functionality, e.g. robot safety related to the first manipulator and motion control thereof. According to at least one example embodiment, the first primary controller comprises a controller interface, e.g., Ethernet, Fieldbus slave, TPU, PC interface, safety signals, or discrete I/O. The safety functionality of the first primary controller may comprise a safety interface, e.g. as a discrete signal or through safety fieldbus.

According to at least one example embodiment, the first primary controller comprises a power supply unit, and/or a drive unit. According to at least one example embodiment, the first primary robot functionality of the first primary controller includes the control of the power supply unit and/or the control of the drive unit. For example, the first primary controller may be configured to supply power from the power supply unit to the drive unit and/or the computer and logic unit, and/or be configured to enable the power and logic unit to directly communicate with the drive unit.

According to at least one example embodiment, the drive unit is configured to operate the first manipulator or manipulator arm, and any tool attached to the first manipulator or manipulator arm. It should be noted that according to at least one example embodiment, the drive unit and/or the power supply unit of the first manipulator is arranged outside/external of the first primary controller.

According to at least one example embodiment, at least one of, or all, of the following functions are excluded from the first primary robot functionality: fieldbus master, overall robot process control, support to additional/external drive units, synchronized robot motion control.

According to at least one example embodiment, the secondary robot functionalities of the plurality of secondary controllers include the control of at least one of: support to additional/external drive units, overall robot process control, robot cell I/O, external robot process equipment, synchronized robot motion control, HMI, and overall robot safety. Thus, according to at least one example embodiment, such functionality is not included in the first primary robot functionality.

According to at least one example embodiment, the plurality of secondary controllers includes at least one of the following: robot cell controller, machine controller, edge, or line controller, a second robot primary controller.

All of the mentioned secondary controllers are typically arranged externally of the robot. According to at least one example embodiment, the secondary controllers include at least a network-based server, such as e.g. a cloud server.

According to at least one example embodiment, the industrial robot system further comprises a second robot having a second manipulator with a base and a tool movable in relation to the base about a plurality of axes, and a second primary controller having second primary robot functionality, the second primary robot functionality including motion control of the second manipulator, wherein an overall functionality of the second robot is defined by the second primary robot functionality and one or more secondary robot functionalities.

Hereby, at least two robots can be set up by the same configuration, and the same secondary controllers can be used to extend the functionality of the first and second robot, respectively. The second robot may e.g., be comprised in the same robot cell as the first robot.

Effects and features of this second robot are largely analogous to those described above in connection with the first robot. Embodiments mentioned in relation to the first robot are largely compatible with the second robot.

According to at least one example embodiment, motions of the first and second manipulators are synchronized to form a multiple robot motion system.

Hereby, an effective multiple robot motion system is provided. According to at least one example embodiment, the functionality of synchronized motion of the first and second manipulators is comprised in one of the secondary controllers.

In other words, at least one of the secondary controllers is configured to synchronize motion of the first and second manipulators to form a multiple robot motion system. Such secondary controllers may be operating, and communicating, with the first and second robots via the network arrangement.

According to a second aspect of the present invention, a method for distributing robot functionality of the first robot is provided. The robot comprises a first manipulator, and the method comprises the steps of
operating the first robot with a first primary robot functionality by a first primary controller, the primary robot functionality including control of manipulator motion,
operating the first robot with a secondary robot functionality different to said first primary robot functionality, by at least one of a plurality of secondary controllers, whereby an overall functionality of the first robot is defined by the first primary robot functionality and one or more secondary robot functionalities.

Effects and features of this second aspect of the invention are largely analogous to those described above in connection with the first aspect of the invention. Embodiments mentioned in relation to the first aspect of the invention are largely compatible with the second aspect of the invention, of which some are exemplified below.

For example, the first primary robot functionality is different to said secondary robot functionalities in the same manner as explained with reference to the first aspect of the invention.

According to at least one example embodiment, the method further comprises the steps of
operating a second robot with second primary robot functionality by a second primary controller, the second primary robot functionality including motion control of a second manipulator,
operating the first and second robots by synchronized motion of the first and second manipulators to form a multiple robot motion system, wherein the functionality of the synchronized motion of the first and second manipulators is comprised in one of the secondary controllers.

Further advantages and features of the present disclosure are disclosed and discussed in the following description and the accompanying drawings.

### BRIEF DESCRIPTION OF THE DRAWINGS

These and other aspects of the present inventive concept will now be described in more detail, with reference to the appended drawings showing an example embodiment of the inventive concept, wherein:

FIG. 1 schematically illustrates a robot cell with two robots together with corresponding primary controllers and further controller entities,

FIG. 2 schematically illustrates the primary controllers and secondary controllers connected to a local communication network, which in turn is connected to the internet,

FIG. 3 shows a block schematic of relevant parts of the first primary controller, and

FIG. 4 shows a block schematic of a network-based robot system using a primary controller and secondary controllers.

### DETAILED DESCRIPTION

In the following description, for purposes of explanation and not limitation, specific details are set forth such as particular components, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail.

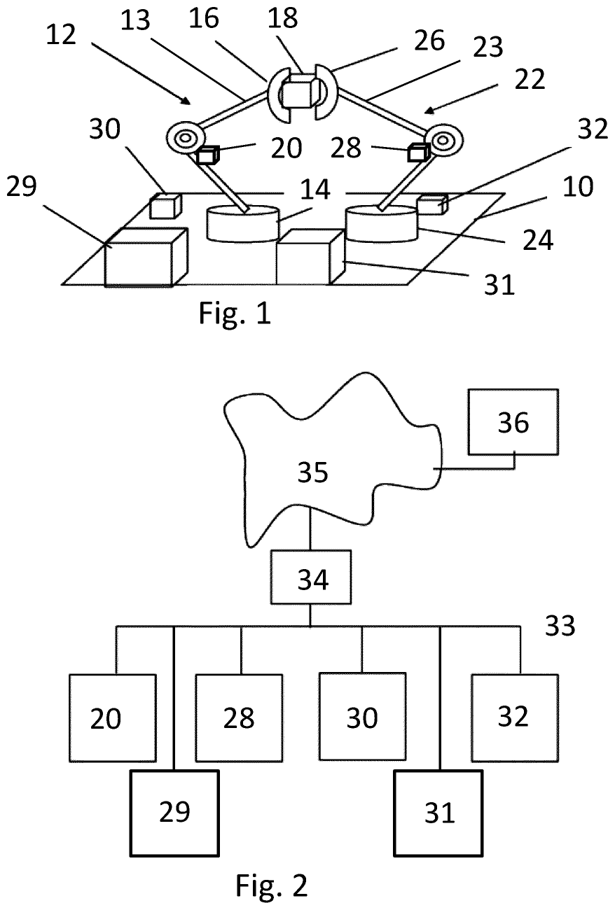

FIG. 1 schematically shows a robot cell 10. The robot cell 10 comprises an area in which there is a first robot 12, which first robot 12 is equipped with a first manipulator 13 comprising a first base 14 and a first tool 16 for holding an object 18, and where the object may be a product or may be used in the forming of a product. In the robot cell 10 there is also a second robot 22, which second robot 22 is equipped with a second manipulator 23 comprising a second base 24 and a second tool 26 for holding an object 18, which in this case is the same object 18 held by the first robot 12. Therefore, the two robots 12 and 22 are here cooperating with synchronized motions of the first and second manipulators 13, 23, in the handling of the object 18.

The number of robots shown in the robot cell is exemplifying. It should be realized that there may be more robots in the robot cell, but also fewer. However, all robots in the robot cell are members of a common collaborative group, i.e. a group collaborating in performing a number of correlated or synchronized activities such as for producing products or holding objects.

The first robot 12 is, as was mentioned above, in this example involved in the production of a product. This means that the first tool 16 may be moved along a first robot movement path while performing a first number of activities. In a similar manner the second tool 26 may be moved along a second robot movement path while performing a second number of activities.

In order to perform primary control of the first and second robots 12, 22, and specifically the first and second manipulators 13, 23, as well as processing in relation to these activities, there is furthermore a first primary controller 20 integrated into the first robot 12 for controlling the first manipulator 13, and a second primary controller 28 integrated into the second robot 22 for controlling the second manipulator 23. The first and second primary controllers 20 and 28 are both examples of controller entities that comprise process software and hardware resources configured to carry out certain functions related to the first and second robot 12, 22, respectively. Here, the first and second primary controllers 20 and 28 are both configured to perform a respective primary robot functionality including control of manipulator motion.

Each functionality or function is associated with at least one robot activity, typically an associated number of activities, to perform a specific task. The functionality or functions are executed by a processing unit in respect of the robot cell and in this case also in respect of a corresponding robot. It should be noted that the terms “functionality” and “functions” are used interchangeably throughout the text.

In, or at, the robot cell 10 there may be a number of further controller entities, here referred to as secondary controllers. As an example there is a first robot cell controller 30 which comprises process software and hardware resources configured to carry out certain functions, typically different to the functions included in the first and second primary controllers 20, 28. The first robot cell controller 30 may further comprise a processing unit that processes data to carry out the associated functions, and/or data provided externally of the robots, for example by a first sensor being e.g. a camera or a temperature sensor. The robot cell 10 may further comprise a second robot cell controller 32 which comprises process software and hardware resources configured to carry out certain functions, typically different to the functions included in the first and second primary controllers 20, 28. Correspondingly, the second robot cell controller 32 may further comprise a processing unit that processes data to carry out the associated functions, and possibly data provided externally of the robots, for example by a second sensor, being e.g. a camera or a temperature sensor. The functionalities of the first and second robot cell controllers 30, 32 are referred to as secondary robot functionalities, which thus is secondary to the primary robot functionalities of the first and second primary controllers 20, 28.

Other controller entities, being in the robot cell 10 or in the near vicinity of the robot cell 10, are exemplified in FIG. 1 as a first edge/line controller 29 and a second edge/line controller 31. Correspondingly, each one of the first and second edge/line controllers 29, 31 comprises process software and hardware resources configured to carry out certain functions, typically different to the functions included in the first and second primary controllers 20, 28 and/or to the functions included in the first and second robot cell controllers 30, 32. Each one of the first and second edge/line controllers 29, 31 comprise a processing unit that processes data to carry out the associated functions, and/or data provided externally of the robots. Correspondingly, the functionalities of the first and second edge/line controllers 29, 31 are also referred to as secondary robot functionalities, which thus is secondary to the primary robot functionalities of the first and second primary controllers 20, 28.

The first robot cell controller 30, and the first edge/line controller 29, may for example be configured to complement the first robot 12 with functions not included in the first primary controller 20. Correspondingly, the second robot cell controller 32, and the second edge/line controller 31, may for example be configured to complement the second robot 22 with functions not included in the second primary controller 28. Hereby, the functionality of first and the second robots 12, 22 can be built up by building blocks, where each building block is associated with certain functions of the corresponding robot. Thus, the functionality of each robot can be scaled up, or extended, based on the needs by adding one or more of the building blocks (i.e., one or more of the secondary functionalities of the secondary controllers such as the robot cell or edge/line controllers).

FIG. 2 schematically shows the various controller entities 20, 28, 30, 32 of the robot cell 10, such as the first and second primary controllers 20, 28 and other secondary controllers 30, 32. In FIG. 2, also secondary controllers 29, 31, 36 outside of the robot cell 10 are shown, wherein at least some of the secondary controllers 29, 30, 31, 32 are connected to a local communication network, LCN, 33, such as a local area network (LAN), which may be a private network with restricted access. To this local communication network 33 there is also connected a gateway 34, which provides connectivity for devices of the local communication network 33 to a public network 35 such as the Internet, IN. Via the gateway 34 the controlling entities may for instance access a cloud computing device 36, which may be a cloud computing server in a cloud computing service center or a premises server park (local cloud). Also, this cloud computing device 36 may be a controlling entity, such as secondary controller, comprising process software and hardware resources configured to carry out secondary robot functionality, and/or performing processing associated with the robot cell, which may be processing for one or more of the robots of the collaborative group.

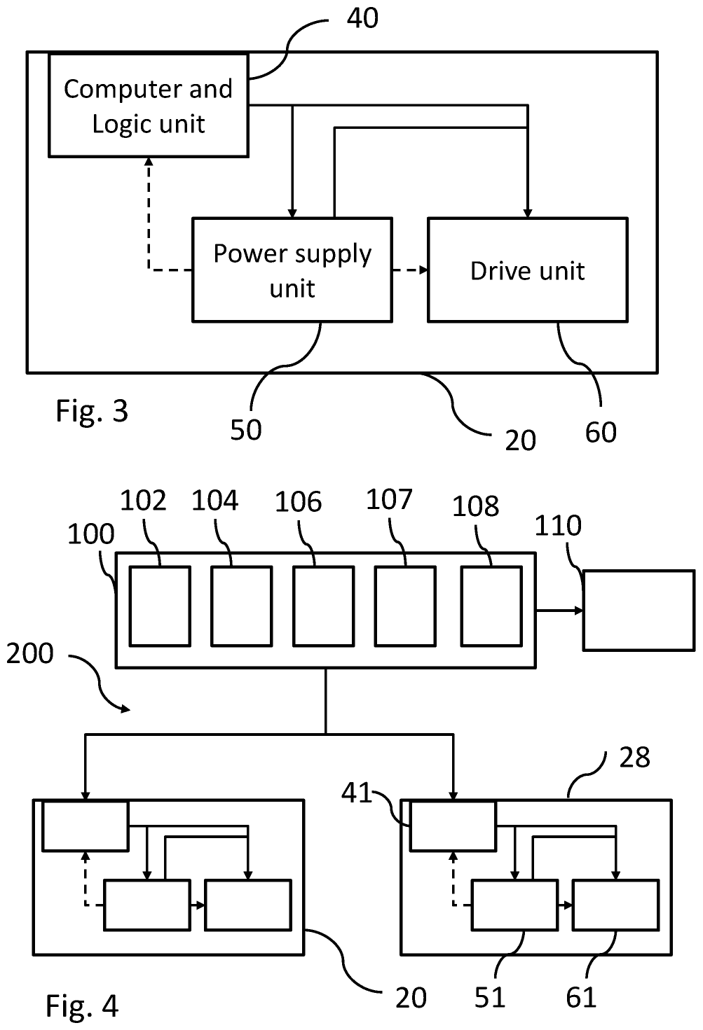

FIG. 3 shows a block schematic of some of the elements of the first primary controller 20 that are relevant to the present invention. It comprises a computer and logic unit 40 typically including, or being connected to, a memory, and serving as a communication interface for communicating on the local communication network 33. The first primary controller 20 further comprises a power supply unit 50 and a drive unit 60. The computer and logic unit 40 may be coupled to the drive unit 60 directly, or by a daisy-chain communication link involving the power supply unit 50. The drive unit 60 controls the first manipulator 13 and may also control the first tool 16, and operate them according to instructions given by the computer and logic unit 40. The first tool 16 may alternatively be controlled by a local I/O of the computer and logic unit 40. Hereby, the first manipulator 13 and the first tool 16 are able to perform a number of activities associated with the first primary robot functionality enabled by the computer and logic unit 40. The power supply unit 50 powers the computer and logic unit 40 (e.g., by 24 V logic power) and the drive unit 60 (e.g., by a DC bus). For example, the computer and logic unit 40 of the first primary controller 20 may be involved in the functionality for the first robot 12 to perform various activities along the first robot movement path. The functionality may involve generating positions that the first tool 16 is to be moved to, and performing commands or actions by the first tool 16. However, the computer and logic unit 40 may also involve other types of functionalities, such as processing, e.g. image processing in order to detect objects to be picked and processing determining which object to pick.

Although the computer and logic unit 40 is shown as being a single unit, the functionality thereof may be separated into multiple units, e.g. a separate processor, and separate memory, etc. It should also be realized that the first primary controller 20 may comprise more elements and units. However, as these are not central to the understanding of the invention, they have been omitted. Moreover, the power supply unit 50 and/or the drive unit 60 can be arranged outside of the first primary controller 20.

As was mentioned earlier, the first primary robot functionality of the first primary controller 20 may be provided through computer and logic unit 40 and associated processor and memory. It may therefore as an example be provided in the form of a processor with an associated computer program code carrying out functions provided as a program code in the memory being run by the processor. As an alternative the computer and logic unit 40 may be provided in the form of an Application Specific Integrated Circuit (ASIC) or Field-Programmable Gate Array (FPGA).

FIG. 4 shows a block schematic of the primary controller of FIG. 3, and associated network-based robot system 200 in which the first primary controller 20 is connected to a secondary controller 100, being e.g., a robot cell controller (as the first robot cell controller 30) or a line/edge controller (as the first line edge controller 29). The named secondary controller is here referring to a controller being secondary in its functionality as compared to the primary controller being primary in its functionality. The first primary controller 20 may e.g., integrated into the manipulator or other component of the associated robot, while the secondary controllers may be arranged externally of the robot.

As shown in FIG. 4, the secondary controller 100 comprises process software and hardware resources configured to carry out certain functions associated with its secondary robot functionality, which are not provided by the computer and logic unit 40 of the first primary controller 20. Such functions are here exemplified by HMI, human-machine interaction function 102, overall robot motion control or overall robot process control, such as e.g., synchronized robot motion control function 104, and overall robot safety control 106. Hereby, the functionality of the first robot 12 can be increased, or extended, beyond the first primary robot functionality provided by the first primary controller 20, as the functions of the secondary controller 100 can be used in addition to the functions of the first primary controller 20. Moreover, the secondary controller 100 may comprise a drive unit 108 configured to operate a robot or servo motor 110 according to the functions 102, 104, 106 of the secondary controller 100. Typically, the secondary controller 100 comprises a power supply unit powering the secondary controller 100.

Moreover, in FIG. 4, two primary controllers 20, 28 are shown interconnected to each other via the network-based robot system 200. Here, the second primary controller 28 of the second robot 22 and some of the elements of the second primary controller 28 that are relevant to the present invention are visualized. Correspondingly to the first primary controller 20, the second primary controller 28 comprises a computer and logic unit 41 typically including, or being connected to, a memory, and serving as a communication interface for communicating on the local communication network 33, here with the secondary controller 100. The second primary controller 28 further comprises a power supply unit 51 and a drive unit 61. The drive unit 61 controls the second manipulator 23 and may also control the second tool 26 of the second robot 22, and operate them according to instructions given by the computer and logic unit 41. The second tool 26 may alternatively be controlled by a local I/O of the computer and logic unit 41. Hereby, the second manipulator 23 and possibly the second tool 26 are able to perform a number of activities associated with the second primary robot functionality enabled by the computer and logic unit 41. The power supply unit 51 powers the computer and logic unit 41 (e.g., by 24 V logic power) and the drive unit 61 (e.g., by a DC bus).

Thus, the secondary controller 100 may communicate with the second primary controller 28 as well, and may thus complement the functionality of the second robot 22 beyond the second primary robot functionality available through the second primary controller 28.

Thus, the functionality of the first and second robots 12, 22 is scalable by the first and second primary controllers, 20, 28 and their networked connected secondary controller 100, making up a network-based robot system.

The secondary controller 100 of FIG. 4 may e.g., be a robot cell controller, but it should be understood that another controller entity associated with other secondary functionality are within the scope of the invention. The secondary controller 100 may e.g., be an edge/line controller without the drive unit 108 shown in FIG. 4. Instead, the edge/line controller may be connected via the network to a servo drive and motor to carrying out its associated functions. Moreover, at least one of the above functions 102, 104, 106 may be located outside of the secondary controller 100, e.g. in the cloud server 36 shown in FIG. 2.

By connecting at least two primary controllers 20, 28 via the secondary controller 100, and through the network, a multiple robot motion system can be built up. The multiple motion system may e.g., support synchronous and asynchronous robot motion, such as e.g. the handling of object 18 by the first and the second tools 16, 26. The multiple motion system may e.g. be embodied as the above-mentioned function of motion control 104 in the secondary controller 100. Hereby, the motion controlled by the first and second primary controllers 20, 28 (which here are connected to the same network) can be synchronized with a robot motor and/or additional motors controlled directly by the secondary controller 100.

According to at least one example embodiment, the first and second primary controllers 20, 28 can be configured to dynamically connect to or disconnect from the network.

According to at least one example embodiment, the network could be shared by several robot cell controllers allowing for the first and second primary controllers 20, 28 to be connected to different robot cell controllers. This is especially advantageous in a mobile robot environment in which the robots can be used by several robot cell controllers at different times and different locations.

The network topology is not limit to the star topology as disclosed in FIG. 4, but may e.g., be daisy chain or a combination of both star and daisy chain. The secondary controller 100 may comprise additional computing power for handling multiple robots, synchronous additional motors, and safety control.

Thus, the network and the secondary controller 100 (e.g., robot safety functions) can extend the respective capability of the first and second primary controllers 20, 28, and additionally enable a multiple robot motion system providing e.g., synchronous multiple robot motion.

The network-based robot system 200 using primary controllers 20, 28 and at least one secondary controller 100 as disclosed in FIG. 4 thus provides an arrangement for distributing functionality for the first robot 12 in a robot cell 10 among more than one controlling entities. In the above given example, the controlling entities are the first primary controller 20, the second primary controller 28, and the secondary controller 100. It should be realized that a certain functionality, besides the first primary robot functionality of first robot, which may be at least, or solely, the motion control of the first manipulator 13, is typically not provided in the first primary controller 20. It may as an example be provided in another controlling entity of the robot cell. It may even be provided in a separate controlling entity connected to the local communication network 33 and may in this case be grouped together with another controlling entity provided for other robot cells. In such a case any such controlling entity will be a secondary controller and form part of the arrangement.

The network-based robot system 200 may further comprise a functionality determining unit 107 configured to obtain data about available functionality/functionalities for e.g., the first robot 12. The functionality determining unit 107 may also be configured to determine, based on the available functionality/functionalities, whether a desired robot performance can be carried out or not. The functionality determining unit 107 may be included in a secondary controller (as e.g., in FIG. 4) or in one of the primary controllers 20, 28, such as e.g. the first primary controller 20.

The above-mentioned functionality of the various controller entities has mainly been described with reference to an associated hardware resource such as e.g., a processing unit being provided in the form of one or more processors together with process software including computer program memory including computer program code for performing its function. As an alternative it may be provided in the form of an Application Specific Integrated Circuit (ASIC) or Field-Programmable Gate Array (FPGA). This computer program code may also be provided on one or more data carriers which perform the functionality of the controlling entity when the program code thereon is being loaded in a processing entity of the robot or robot cell in which the processing entity is to be provided. One such data carrier with computer program code, is in the form of a CD ROM disc. Such computer program may as an alternative be provided on a server and downloaded therefrom into the processing entity in question.

Therefore, while the invention has been described in connection with what is presently considered to be most practical and preferred embodiments, it is to be understood that the invention is not to be limited to the disclosed embodiments, but on the contrary, is intended to cover various modifications and equivalent arrangements. Additionally, variations to the disclosed embodiments can be understood and effected by the skilled person in practicing the claimed inventive concept, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. An industrial robot system comprising a first robot, the first robot comprising a first manipulator with a base and a tool movable in relation to the base about a plurality of axes, and a first primary controller having a first primary robot functionality, the first primary robot functionality including control of manipulator motion, wherein the industrial robot system further includes a plurality of secondary controllers, each having a secondary robot functionality, wherein the primary robot functionality is different from all of said secondary robot functionalities, and wherein an overall robot functionality is defined by the primary robot functionality and one or more secondary robot functionalities.

2. The industrial robot system according to claim 1, wherein the first primary controller is integrated into the first manipulator.

3. The industrial robot system according to claim 1, wherein the plurality of secondary controllers is arranged externally of the first manipulator.

4. The industrial robot system according to claim 1, further comprising a network arrangement for distributing robot functionality of the first robot among the first primary controller and one or more of the secondary controllers.

5. The industrial robot system according to claim 4, wherein the network arrangement comprises a functionality determining unit configured to obtain data about available functionality for the first robot and to determine, based on said available functionality, whether a desired robot functionality can be carried out or not.

6. The industrial robot system according to claim 1, wherein none of the second robot functionalities is included in the primary robot functionality.

7. The industrial robot system according to claim 1, wherein the first primary controller, and each secondary controller, includes process software and hardware resources to carry out the associated functions of the primary and secondary robot functionalities.

8. The industrial robot system according to claim 1, wherein the primary robot functionality includes the control of at least integrated process equipment of the robot.

9. The industrial robot system according to claim 1, wherein the secondary robot functionality includes the control of at least one of: support to additional/external drive units, overall robot process control, robot cell I/O, external robot process equipment, synchronized robot motion control, HMI, and overall robot safety.

10. The industrial robot system according to claim 1, wherein the plurality of secondary controllers includes at least one of the following: robot cell controller, machine controller, edge, or line controller, a second robot primary controller.

11. The industrial robot system according to claim 1, further comprising a second robot having a second manipulator with a base and a tool movable in relation to the base about a plurality of axes, and a second primary controller having a second primary robot functionality, the primary robot functionality including motion control of the second manipulator, wherein an overall robot functionality of the second robot is defined by the primary robot functionality and one or more secondary robot functionalities.

12. The industrial robot system according to claim 11, wherein motions of the first and second manipulators are synchronized to form a multiple robot motion system.

13. The industrial robot system according to claim 12, wherein the functionality of the synchronized motion of the first and second manipulators is included in one of the secondary controllers.

14. A method for distributing robot functionality of a first robot, the first robot comprising a first manipulator, the method comprising the steps of:
operating the first robot with a primary robot functionality by a first primary controller, the primary robot functionality including control of manipulator motion,
operating the first robot with a secondary robot functionality different to said primary robot functionality, by at least one of a plurality of secondary controllers, whereby an overall functionality of the first robot is defined by the primary robot functionality and one or more secondary robot functionalities.

15. The method of claim 14, further comprising the steps of:
operating a second robot with primary robot functionality by a second primary controller, the primary robot functionality including motion control of a second manipulator,
operating the first and second robots by synchronized motion of the first and second manipulators to form a multiple robot motion system, wherein the functionality of the synchronized motion of the first and second manipulators is included in one of the secondary controllers.

16. The industrial robot system according to claim 2, wherein the plurality of secondary controllers is arranged externally of the first manipulator.

17. The industrial robot system according to claim 2, further comprising a network arrangement for distributing robot functionality of the first robot among the first primary controller and one or more of the secondary controllers.

18. The industrial robot system according to claim 2, wherein none of the second robot functionalities is included in the primary robot functionality.
